(19) United States
(12) Patent Application Publication
(10) Pub. No.: US 2013/0184976 A1
(43) Pub. Date: Jul. 18, 2013

(54) DRIVING SUPPORT APPARATUS AND DRIVING SUPPORT METHOD

(71) Applicants: Tomonori Akiyama, Susono-shi (JP); Shinji Igarashi, Susono-shi (JP); Yuki Yoshihama, Susono-shi (JP)

(72) Inventors: Tomonori Akiyama, Susono-shi (JP); Shinji Igarashi, Susono-shi (JP); Yuki Yoshihama, Susono-shi (JP)

(73) Assignee: TOYOTA JIDOSHA KABUSHIKI KAISHA, Toyota-shi, Aichi-ken (JP)

(21) Appl. No.: 13/825,909

(22) PCT Filed: Sep. 27, 2011
(86) PCT No.: PCT/IB11/02238

§ 371 Date: Mar. 25, 2013

(30) Foreign Application Priority Data
Oct. 1, 2010 (JP) 2010-224158

(51) Int. Cl. G06F 17/00

(52) U.S. Cl. CPC G06F 17/00
USPC 701/116

(57) ABSTRACT

In a driving support apparatus that sets a running road, on which a vehicle is able to run, on the basis of a road marking that indicates a lane boundary or a prohibited area and that, when the vehicle deviates from the running road, issues a warning or performs assisting so as to cause the vehicle to run within the running road, when the width of a lane defined by the road marking that indicates the lane boundary is narrow, the running road is set by allowing a deviation from the lane having a narrow width. It is possible to effectively utilize the driving support apparatus by increasing a chance of using the driving support apparatus without unnecessary support.

### BACKGROUND OF THE INVENTION

1. Field of the Invention

The invention relates to a driving support apparatus and a driving support method.

2. Description of Related Art

There has been disclosed a technique by which, when two white lines on a road have been detected as road markings that indicate lane boundaries, steering of a vehicle is controlled on the basis of these two white lines; whereas, when white lines cannot be detected, steering of the vehicle is controlled on the basis of distances to side walls (for example, see Japanese Patent Application Publication No. 10-031799 (JP-A-10-031799)). With the technique described in JP-A-10-031799, even when there is a thin spot or a break in white lines, it is possible to maintain control over steering of the vehicle on the basis of distances to side walls.

In the driving support apparatus that controls the vehicle on the basis of detected white lines and that is described in JP-A-10-031799, the width of a lane defined by white lines is wide in an expressway, or the like, and vehicle control based on detected white lines is effective. However, the width of a lane defined by white lines may be narrow in an ordinary road, or the like, and a vehicle often runs over a white line or runs across a white line, so vehicle control based on detected white lines may be unnecessary support for a vehicle driver's intentional operation. Therefore, it is conceivable that, in the case of an ordinary road, or the like, of which the width of a lane defined by white lines is narrow, a vehicle is not controlled on the basis of detected white lines. However, if the control is not executed at all, a chance of using the driving support apparatus equipped for the vehicle is reduced, and the driving support apparatus may not be effectively utilized.

### SUMMARY OF THE INVENTION

The invention provides a technique for effectively utilizing a driving support apparatus by increasing a chance of using the driving support apparatus without unnecessary support.

A first aspect of the invention provides a driving support apparatus. In the driving support apparatus that sets a running road, on which a vehicle is able to run, on the basis of a road marking that indicates a lane boundary or a prohibited area and that, when the vehicle deviates from the running road, issues a warning or performs assisting so as to cause the vehicle to run within the running road, when the width of a lane defined by the road marking that indicates the lane boundary is narrow, the running road is set by allowing a deviation from the lane having a narrow width.

According to the first aspect of the invention, even when the width of a lane defined by a road marking that indicates a lane boundary is narrow, a running road is set by allowing a deviation from the lane having a narrow width, and then the driving support apparatus may be operated. By so doing, it is possible to perform supporting so as to cause the vehicle to run within the running road without unnecessary support in the case where the vehicle deviates from a road marking that indicates a lane boundary that defines a lane having a narrow width. Thus, it is possible to effectively utilize the driving support apparatus by increasing a chance of using the driving support apparatus without unnecessary support.

Note that, here, the road marking that indicates a lane boundary may be a line such as a white line, a yellow line and a dotted line, a median strip or a divider such as a raised marker and an illuminator, a boundary between a roadway and an area other than the roadway such as a boundary between asphalt and gravel, or the like, on a road surface. The prohibited area may be an obstacle, such as a side wall, a curb, a pedestrian, a bicycle and another vehicle, or an area, such as a gutter and a step, that has a difference in height from a vehicle running plane. The prohibited area not only includes an area in which a vehicle is not able to run but also an area in which a vehicle is not allowed to run and an area in which a vehicle is not desired to run.

In addition, the timing at which the vehicle deviates from the running road used to issue a warning or perform assisting according to the aspect of the invention may be immediately before the vehicle deviates from the running road, just the moment at which the vehicle deviates from the running road or immediately after the vehicle deviates from the running road.

In addition, the running road may be set with reference to the prohibited area outside the lane having a narrow width.

By so doing, it is possible to set a running road that avoids a prohibited area outside of a lane having a narrow width while allowing a deviation from the lane having a narrow width.

In addition, the running road may be set by changing a degree of influence of the road marking that indicates the lane boundary that defines the lane having a narrow width in response to the width of the lane having a narrow width.

By so doing, for example, as the width of the lane having a narrow width reduces, the degree of influence of the road marking that indicates the lane boundary that defines the lane having a narrow width is reduced, and then a running road is set by increasing the amount by which the running road projects outward from the road marking. On the other hand, as the width of the lane having a narrow width increases, the degree of influence of the road marking that indicates the lane boundary that defines the lane having a narrow width is increased, and then a running road is set by reducing the amount by which the running road projects outward from the road marking. By so doing, a running road may be set so that the driving support apparatus is able to operate optimally.

In addition, the running road may be set by setting parallel lines that are parallel to the road marking that indicates the lane boundary that defines the lane having a narrow width and that deviate from the lane having a narrow width.

By so doing, it is possible to set a running road along a lane having a narrow width while allowing a deviation from the lane having a narrow width.

In addition, a second aspect of the invention provides a running support method. The running support method includes: setting a running road, on which a vehicle is able to run, on the basis of a road marking that indicates a lane boundary or a prohibited area, wherein, when the width of a lane defined by the road marking that indicates the lane boundary is narrow, the running road is set by allowing a deviation from the lane having a narrow width; and, when the vehicle deviates from the running road, issuing a warning or performing assisting so as to cause the vehicle to run within the running road.

According to the second aspect of the invention as well, it is possible to effectively utilize the driving support apparatus by increasing a chance of using the driving support apparatus without unnecessary support.

According to the first and second aspects of the invention, it is possible to effectively utilize the driving support apparatus by increasing a chance of using the driving support apparatus without unnecessary support.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram that shows the configuration of a driving support apparatus according to a first embodiment of the invention function by function;

FIG. 2 is a view that shows a situation in which, when road markings that indicate a lane boundary are detected on both sides of a lane, a temporary running road that deviates from the lane is set according to a first embodiment;

FIG. 3 is a view that shows a situation in which, when a road marking that indicates a lane boundary is detected on one side of a lane, a temporary running road that deviates from the lane is set according to the first embodiment;

FIG. 4A and FIG. 4B are views that respectively show situations in which, when it is determined that there are prohibited areas in a temporary running road, the temporary running road is narrowed so as to avoid the prohibited areas to set a regular running road according to the first embodiment; and

FIG. 5 is a flowchart that shows an integrated recognition processing control routine according to the first embodiment.

### DETAILED DESCRIPTION OF EMBODIMENTS

Hereinafter, a specific embodiment of the invention will be described. Here, a driving support apparatus that recognizes a lane or a prohibited area to set a running road of a vehicle and executes driving support process for preventing a deviation of the vehicle from the set running road will be described. Note that the driving support process is executed earlier than collision mitigation process that is executed when the vehicle stops in an emergency or when a collision between the vehicle and an obstacle is unavoidable. In addition, the configuration described in the following embodiment shows one embodiment of the invention and does not limit the configuration of the aspect of the invention.

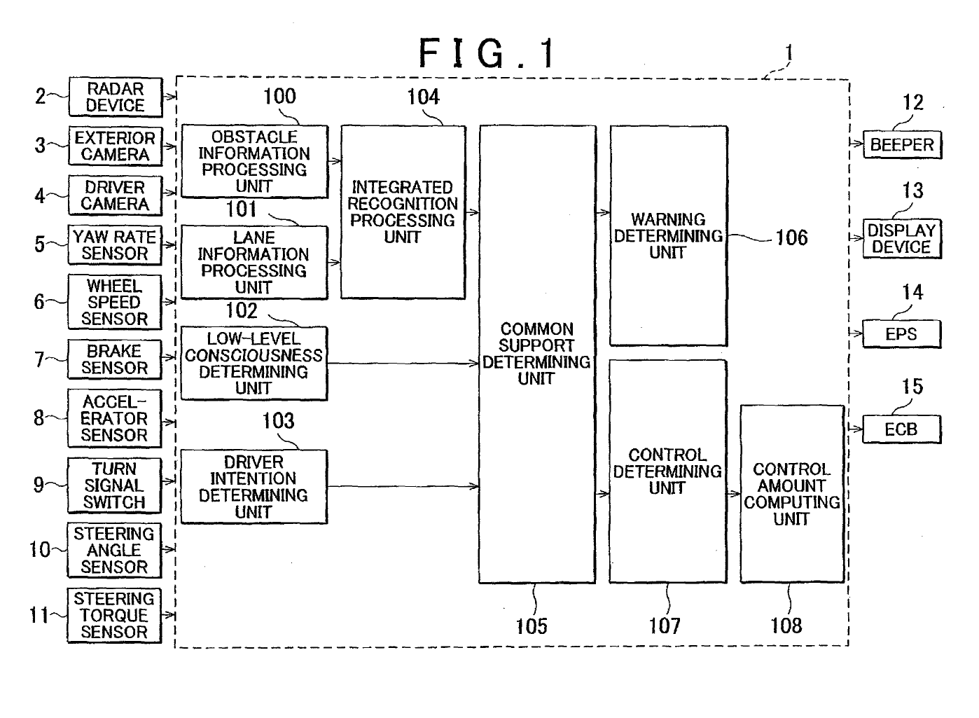

FIG. 1 is a block diagram that shows the configuration of a driving support apparatus according to a first embodiment of the invention function by function. As shown in FIG. 1, the vehicle is equipped with an electronic control unit (ECU) 1 for driving support.

The ECU 1 is an electronic control unit that includes a CPU, a ROM, a RAM, a back-up RAM, an I/O interface, and the like. Various sensors, such as a radar device 2, an exterior camera 3, a driver camera 4, a yaw rate sensor 5, a wheel speed sensor 6, a brake sensor 7, an accelerator sensor 8, a turn signal switch 9, a steering angle sensor 10 and a steering torque sensor 11, are electrically connected to the ECU 1, and signals output from those sensors are input to the ECU 1.

The radar device 2 is attached to the front of the vehicle. The radar device 2 transmits a millimeter wave forward of the vehicle and then receives a reflected wave reflected from an obstacle outside the vehicle, thus outputting information about a relative position of the obstacle with respect to the vehicle (for example, coordinate information). The exterior camera 3 is arranged at a position inside a vehicle cabin at which a view ahead of the vehicle may be captured, and outputs an image ahead of the vehicle. The driver camera 4 is arranged at a position inside the vehicle cabin at which a driver may be captured, and outputs the image of the driver. The yaw rate sensor 5 is attached to a vehicle body, and outputs an electrical signal that correlates with the yaw rate of the vehicle. The wheel speed sensor 6 is attached to the wheel of the vehicle, and outputs an electrical signal that correlates with the running speed of the vehicle.

The brake sensor 7 is attached to a brake pedal inside the vehicle cabin, and outputs an electrical signal that correlates with the operation torque (depression force) of the brake pedal. The accelerator sensor 8 is attached to an accelerator pedal inside the vehicle cabin, and outputs an electrical signal that correlates with the operation torque (depression force) of the accelerator pedal. The turn signal switch 9 is attached to a turn signal lever inside the vehicle cabin. When the turn signal lever is operated, the turn signal switch 9 outputs an electrical signal that correlates with a direction indicated by a turn signal flasher (direction indicator). The steering angle sensor 10 is attached to a steering rod connected to a steering wheel inside the vehicle cabin, and outputs an electrical signal that correlates with a rotation angle of the steering wheel from a neutral position. The steering torque sensor 11 is attached to the steering rod, and outputs an electrical signal that correlates with torque input to the steering wheel (steering torque).

In addition, various devices, such as a beeper 12, a display device 13, an electric power steering (EPS) 14 and an electronically controlled brake (ECB) 15, are connected to the ECU 1, and those various devices are electrically controlled by the ECU 1.

The beeper 12 is a device that is attached inside the vehicle cabin and that outputs a warning sound, or the like. The display device 13 is a device that is attached inside the vehicle cabin and that displays various messages and warning lamps. The electric power steering (EPS) 14 is a device that utilizes torque generated by an electric motor to assist the steering wheel in operation. The electronically controlled brake (ECB) 15 is a device that electrically adjusts the hydraulic fluid pressure (brake fluid pressure) of a friction brake provided for each wheel.

The ECU 1 has the following functions in order to control various devices using signals output from the various sensors. That is, the ECU 1 includes an obstacle information processing unit 100, a lane information processing unit 101, a low-level consciousness determining unit 102, a driver intention determining unit 103, an integrated recognition processing unit 104, a common support determining unit 105, a warning determining unit 106, a control determining unit 107 and a control amount computing unit 108.

The obstacle information processing unit 100 approximately obtains a regression line, by which a plurality of prohibited areas may be avoided, on the basis of pieces of coordinate information of the plurality of prohibited areas, such as obstacles, output from the radar device 2, and generates the coordinate information of the regression line and information including the yaw angle, or the like, of the vehicle with respect to the regression line. In addition, when a single prohibited area, such as an obstacle, has been detected by the radar device 2, the obstacle information processing unit 100 also generates the coordinate information of the prohibited area and information about the yaw angle of the vehicle with respect to the prohibited area. Note that the obstacle information processing unit 100 may generate information about a prohibited area on the basis of an image captured by the exterior camera 3. The prohibited area may be an obstacle, such as a side wall, a curb, a pedestrian, a bicycle and another vehicle, or an area, such as a gutter and a step, that has a difference in height from a vehicle running plane. The prohibited area not only includes an area in which a vehicle is not able to run but also an area in which a vehicle is not allowed to run and an area in which a vehicle is not desired to run.

The lane information processing unit 101 generates information about a lane and information about the attitude of the vehicle with respect to the lane on the basis of an image captured by the exterior camera 3. The information about a lane is information about a road marking that indicates a lane boundary or information about the width of a lane defined by the road marking. The road marking that indicates a lane boundary may be a line such as a white line, a yellow line and a dotted line, a median strip or a divider such as a raised, marker and an illuminator, a boundary between a roadway and an area other than the roadway such as a boundary between asphalt and gravel, or the like, on a road surface. The information about the attitude of the vehicle with respect to a lane is information about a distance between the vehicle and a road marking that indicates a lane boundary, information about the offset amount of a vehicle position with respect to a lane center and information about the yaw angle of a vehicle traveling direction with respect to a road marking that indicates a lane boundary. Note that when the vehicle is equipped with a navigation system, the lane information processing unit 101 may generate information about a lane from map information and GPS information that the navigation system has.

The low-level consciousness determining unit 102 determines the degree of decrease in the consciousness level (arousal level) of a driver on the basis of an image captured by the driver camera 4. The low-level consciousness determining unit 102 computes a driver's eye closure time and eye closure frequency from an image captured by the driver camera 4, and determines that the consciousness level of the driver is low (the arousal level is low) when the eye closure time or the eye closure frequency exceeds an upper limit. In addition, the low-level consciousness determining unit 102 may compute a period of time during which the orientation of the face or eyes of the driver deviates from the vehicle traveling direction from the image captured by the driver camera 4, and may determine that the driver drives the vehicle inattentively when the calculated period of time exceeds an upper limit.

The driver intention determining unit 103 determines whether a variation in the operation amount of the brake pedal, a variation in the operation amount of the accelerator pedal or a variation in the operation (steering) amount of the steering wheel is due to a driver's intention on the basis of signals output from the wheel speed sensor 6, the brake sensor 7, the accelerator sensor 8, the turn signal switch 9, the steering angle sensor 10 and the steering torque sensor 11.

The integrated recognition processing unit 104 sets a running road on which the vehicle is able to run on the basis of the information generated by the obstacle information processing unit 100 and the information generated by the lane information processing unit 101, and obtains the yaw angle of the vehicle with respect to a running road boundary and the offset amount of the vehicle with respect to the running road center. In addition, when the integrated recognition processing unit 104 receives information about a single prohibited area from the obstacle information processing unit 100, the integrated recognition processing unit 104 may extend the length of the prohibited area in parallel with a road to set a running road. That is, the integrated recognition processing unit 104 may recognize a prohibited area detected as a point on coordinates as a line on coordinates to set a running road. At this time, the amount of extension (the length of the line) may be longer when the signal output from the wheel speed sensor 6 (vehicle speed) is high or when the yaw angle of the vehicle with respect to the line is large than when the vehicle speed is low or when the yaw angle with respect to the line is small. Note that the details of the integrated recognition processing unit 104 will be described later.

The common support determining unit 105 determines whether to execute driving support process on the basis of information generated by the integrated recognition processing unit 104, a result determined by the low-level consciousness determining unit 102 and a result determined by the driver intention determining unit 103. The common support determining unit 105 allows executing driving support process when the low-level consciousness determining unit 102 determines that the level of consciousness of the driver is low or when the low-level consciousness determining unit 102 determines that the driver drives the vehicle inattentively. In addition, when the driver intention determining unit 103 determines that the driver performs intentional operation, the common support determining unit 105 limits execution of driving support process.

When the common support determining unit 105 allows executing driving support process, the warning determining unit 106 determines the sound timing at which the beeper 12 sounds and the display timing at which the display device 13 displays a warning message or a warning lamp. When the distance in the vehicle widthwise direction between the vehicle and a running road boundary falls at or below a predetermined distance or becomes 0 or when the vehicle crosses the running road boundary, the warning determining unit 106 may sound the beeper 12 or may display a warning message or a warning lamp on the display device 13. Note that the warning determining unit 106 not only sounds the beeper 12 or displays a warning message or a warning lamp on the display device 13 with reference to a running road boundary but also may potentially recognize a running road boundary widely and increases the sound level of the beeper 12 or increases the size of a warning message or a warning lamp on the display device 13 as the vehicle deviates from the running road. In addition, when a time that elapses until the vehicle arrives at a running road boundary in the vehicle widthwise direction falls at or below a predetermined time, the warning determining unit 106 may sound the beeper 12 or may display a warning message or a warning lamp on the display device 13. In addition, in the case where the vehicle approaches a curve or the vehicle is cornering, when the distance in the vehicle traveling direction between the vehicle and a running road boundary falls at or below a predetermined distance or becomes 0 or when the vehicle crosses the running road boundary, the warning determining unit 106 may sound the beeper 12 or may display a warning message or a warning lamp on the display device 13. In addition, in the case where the vehicle approaches a curve or the vehicle is cornering, when a time that elapses until the vehicle arrives at a running road boundary in the vehicle traveling direction falls at or below, a predetermined time, the warning determining unit 106 may sound the beeper 12 or may display a warning message or a warning lamp on the display device 13. The timing at which the warning determining unit 106 sounds the beeper 12 or the display device 13 displays a warning message or a warning lamp corresponds to the timing at which the vehicle deviates from a running road.

Here, the predetermined distance or predetermined time used by the warning determining unit 106 to sound the beeper 12 or display a warning message or a warning lamp on the display device 13 is a value that is changed in response to a signal output from the wheel speed sensor 6 (vehicle speed) or a signal output from the yaw rate sensor 5 (yaw rate). The predetermined distance is set to be longer or the predetermined time is set to be longer when the vehicle speed is high than when the vehicle speed is low. In addition, a predetermined distance is set to be longer or a predetermined time is set to be longer when the yaw rate is large than when the yaw rate is small.

Note that a method of warning the driver is not limited to sounding the beeper 12 or displaying a warning message or a warning lamp on the display device 13, a method of intermittently changing torque that fastens a seat belt may be, for example, employed.

When the common support determining unit 105 allows executing driving support process, the control determining unit 107 determines the timing at which the electric power steering (EPS) 14 or the electronically controlled brake (ECB) 15 is activated in order to avoid a deviation from a running road. When the distance in the vehicle widthwise direction between the vehicle and a running road boundary falls at or below a predetermined distance or becomes 0 or when the vehicle crosses the running road boundary, the control determining unit 107 may activate the electric power steering (EPS) 14 or the electronically controlled brake (ECB) 15. In addition, when a time that elapses until the vehicle arrives at a running road boundary in the vehicle widthwise direction falls at or below a predetermined time, the control determining unit 107 may activate the electric power steering (EPS) 14 or the electronically controlled brake (ECB) 15. In addition, in the case where the vehicle approaches a curve or the vehicle is cornering, when the distance in the vehicle traveling direction between the vehicle and a running road boundary falls at or below a predetermined distance or becomes 0 or when the vehicle crosses the running road boundary, the control determining unit 107 may activate the electric power steering (EPS) 14 or the electronically controlled brake (ECB) 15. In addition, in the case where the vehicle approaches a curve or the vehicle is cornering, when a time that elapses until the vehicle arrives at a running road boundary in the vehicle traveling direction falls at or below a predetermined time, the control determining unit 107 may activate the electric power steering (EPS) 14 or the electronically controlled brake (ECB) 15. The timing at which the control determining unit 107 activates the electric power steering (EPS) 14 or the electronically controlled brake (ECB) 15 corresponds to the timing at which the vehicle deviates from a running road.

The predetermined distance or predetermined time used by the control determining unit 107 is changed in response to a vehicle speed or a yaw rate as in the case of the predetermined distance or predetermined time used by the warning determining unit 106. For example, the predetermined distance or predetermined time may be set so as to be shorter than the predetermined distance or predetermined time used by the warning determining unit 106.

When the control determining unit 107 issues a request to activate the electric power steering (EPS) 14 or the electronically controlled brake (ECB) 15, the control amount computing unit 108 computes the control amount of the electric power steering (EPS) 14 or the control amount of the electronically controlled brake (ECB) 15, and activates the electric power steering (EPS) 14 or the electronically controlled brake (ECB) 15 in accordance with the calculated control amount. The control amount computing unit 108 computes a target yaw rate required to avoid a deviation from a running road using information generated by the integrated recognition processing unit 104, a signal output from the wheel speed sensor 6 (vehicle speed) and a signal output from the yaw rate sensor 5 (yaw rate) as parameters. More specifically, the control amount computing unit 108 computes a target yaw rate Ytrg through the following mathematical expression where a relative distance to a running road boundary is D, the speed of the vehicle (vehicle speed) is V and the yaw angle of the vehicle with respect to the running road boundary is 0.

Ytrg=(θ·V sin θ)/D

The control amount computing unit 108 obtains the control amount (steering torque) of the electric power steering (EPS) 14 and the control amount (brake hydraulic pressure) of the electronically controlled brake (ECB) 15 using the target yaw rate Ytrg as an argument. At this time, the correlation between a target yaw rate Ytrg and a steering torque and the correlation between a target yaw rate Ytrg and a brake hydraulic pressure may be mapped in advance. Note that, when the target yaw rate Ytrg is smaller than a predetermined value (the maximum value of yaw rate at which a running road deviation may be avoided only by steering), the brake hydraulic pressure of the electronically controlled brake (ECB) 15 may be set to 0. In addition, when different brake hydraulic pressures are respectively applied to friction brakes of right and left wheels of the vehicle at the time when the electronically controlled brake (ECB) 15 is activated, a yaw rate that interferes with the yaw rate generated by the electric power steering (EPS) 14 is generated. Therefore, it is desirable that equivalent brake hydraulic pressures are respectively applied to the friction brakes of the right and left wheels. Note that the control amount computing unit 108 not only activates the electric power steering (EPS) 14 or the electronically controlled brake (ECB) 15 with reference to a running road boundary but also may potentially recognize a running road boundary widely and increases the control amount of the electric power steering (EPS) 14 or the control amount of the electronically controlled brake (ECB) 15 as the direction deviates from a running road.

Note that a method of decelerating the vehicle is not limited to a method that uses the electronically controlled brake (ECB) 15 to activate the friction brakes; it may be a method of converting (regenerating) kinetic energy of the vehicle to electric energy or a method of changing the speed ratio of a transmission to increase engine brake.

With the above described driving support apparatus, it is possible to warn the driver of a deviation from a running road set on the basis of a prohibited area, such as an obstacle, and a lane and to assist in operation for avoiding a running road deviation.

Incidentally, in the driving support apparatus that controls the vehicle on the basis of detected white lines, the width of a lane defined by white lines is wide in an expressway, or the like, and vehicle control based on detected white lines is effective. However, the width of a lane defined by white lines may be narrow in an ordinary road, or the like, and a vehicle often runs over a white line or runs across a white line, so vehicle control based on detected white lines may be unnecessary support for a vehicle driver's intentional operation. Therefore, it is conceivable that, in the case of an ordinary road, or the like, of which the width of a lane defined by white lines is narrow, a vehicle is not controlled on the basis of detected white lines. However, if the control is not executed at all, a chance of using the driving support apparatus equipped for the vehicle is reduced, and the driving support apparatus may not be effectively utilized.

Then, in the driving support apparatus according to the present embodiment, when the width of a lane defined by road markings that indicate a lane boundary is narrow, a running road is set by allowing a deviation of the vehicle from the lane having a narrow width.

Hereinafter, the function of the integrated recognition processing unit 104 according to the present embodiment will be described in detail.

The integrated recognition processing unit 104 sets a running road on which the vehicle is able to run on the basis of the information generated by the obstacle information processing unit 100 and the information generated by the lane information processing unit 101.

At the time of setting a running road, first, it is determined whether a lane may be set as a temporary running road on the basis of the information generated by the lane information processing unit 101. That is, it is determined whether to bring a lane into coincidence with a temporary running road. In this determination, when the width of the lane is narrow, it is determined that the lane is not set as the temporary running road. Note that, here, the temporary running road is a running road that is temporarily set along a lane on the basis of only the information generated by the lane information processing unit 101 as a precondition for setting a regular running road on which the vehicle is able to run.

Here, a criterion used to determine that the width of a lane is narrow is that the width of a lane defined by road markings that are captured by the exterior camera 3 and that indicate a lane boundary is smaller than or equal to a predetermined reference width. In addition, a criterion used to determine that the width of a lane is narrow may by another criterion other than the above criterion. For example, when the vehicle is equipped with a navigation system, information about the road type, number of lanes, and the like, of a road on which the vehicle is running is acquired from map information and GPS information that the navigation system has, and, when the road type is an ordinary city road or a village road (lower than or equal to the third class third grade) or when the number of lanes is 1, there is a high probability that the width of a lane is narrow, so it may be determined that the width of the lane is narrow. In addition, when the average speed in a predetermined period of time up to the current moment is lower than or equal to a predetermined reference speed on the basis of a signal output from the wheel speed sensor 6 (vehicle speed), there is a high possibility that the vehicle is running on a road having a narrow lane, so it may be determined that the width of the lane is narrow. It may be determined on the basis of any one of these conditions solely whether the width of a lane is narrow or it may be determined, on the basis of a combination of these conditions whether the width of a lane is narrow.

When it is determined that the lane may be set as a temporary running road through the above determination, the lane is set as a temporary running road.

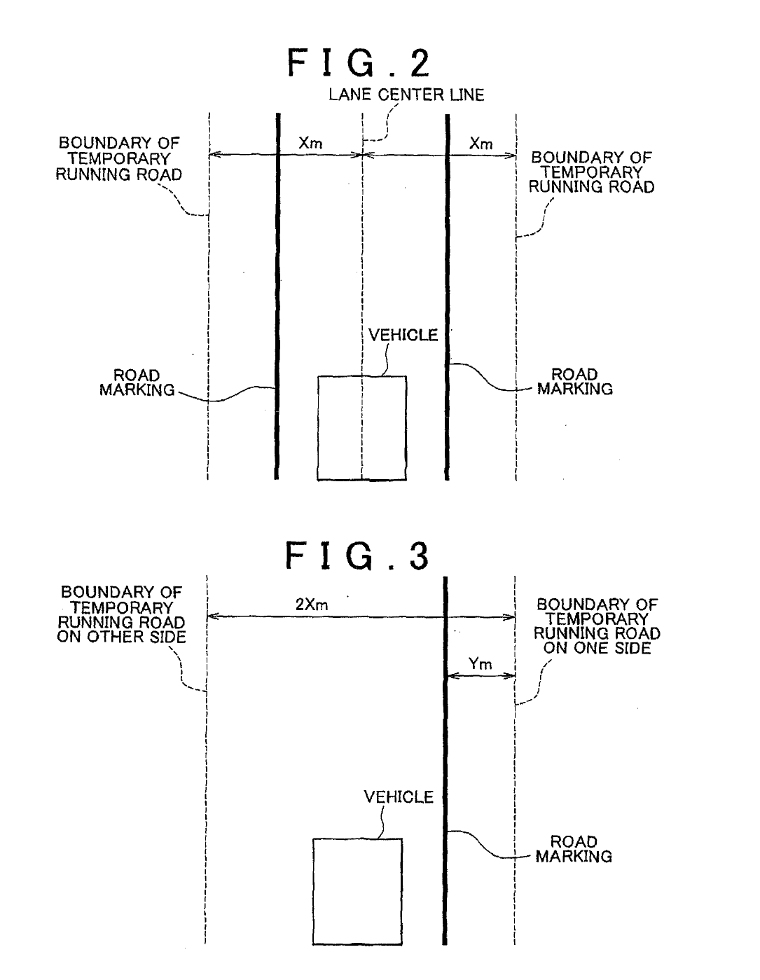

On the other hand, when the width of the lane is narrow and it is determined that the lane may not be set as a temporary running road, a temporary running road that deviates from the lane is set. By so doing, it is possible to set a running road by allowing a deviation from the lane having a narrow width. FIG. 2 is a view that shows a situation in which, when road markings that indicate a lane boundary are detected on both sides of a lane, a temporary running road that deviates from the lane is set. A temporary running road that deviates from a lane is set in such a manner that, when road markings that indicate a lane boundary are detected on both sides of a lane, as shown in FIG. 2, a lane center line between the road markings on both sides is calculated and then boundaries on both sides of the temporary running road are set at positions, which are located outside of the road markings, a predetermined distance (Xm) away from the lane center line toward both sides. In addition, FIG. 3 is a view that shows a situation in which, when a road marking that indicates a lane boundary is detected on one side of a lane, a temporary running road that deviates from the lane is set. A temporary running road that deviates from a lane is set in such a manner that, when a road marking that indicates a lane boundary is detected on one side of a lane, as shown in FIG. 3, a boundary on one side of the temporary running road is set at a position a predetermined distance (Ym) away from a one-side road marking and then a boundary on the other side of the temporary running road is set at a position a predetermined distance (2Xm (2Xm>Ym)) away from the boundary toward the opposite side of the lane with reference to the boundary on one side of the set temporary running road. Note that there is a possibility that a prohibited area may be present in a temporary running road; however, a temporary running road is set on the basis of only the information generated by the lane information processing unit 101, so the presence of a prohibited area is ignored. By so doing, it is possible to set a temporary running road by setting parallel lines that are parallel to the road marking indicating a lane boundary that defines a lane having a narrow width and that deviate from the lane having a narrow width. Thus, it is possible to set a temporary running road along a lane having a narrow width while allowing a deviation from the lane having a narrow width.

Note that, here, a temporary running road that is set to deviate from the lane when the width of the lane is narrow and it is determined that the lane may not be set as a temporary running road may be set by changing the degree of influence of a road marking that indicates a lane boundary that defines the lane having a narrow width in response to the width of the lane having a narrow width. For example, as the width of the lane having a narrow width reduces, the degree of influence of a road marking that indicates a lane boundary that defines the lane having a narrow width is reduced, and then a temporary running road is set by increasing the amount by which the temporary running road projects outward from the road marking. On the other hand, as the width of the lane having a narrow width increases, the degree of influence of a road marking that indicates a lane boundary that defines the lane having a narrow width is increased, and then a temporary running road is set by reducing the amount by which the temporary running road projects outward from the road marking. The width of the temporary running road set here may be substantially constant or may be variable in response to the width of a lane having a narrow width. By so doing, a temporary running road may be set so that the driving support apparatus is able to operate optimally. Note that, in this case as well, a temporary running road may be set by setting parallel lines that are parallel to the road marking indicating a lane boundary that defines a lane having a narrow width and that deviate from the lane having a narrow width. By so doing, it is possible to set a temporary running road along a lane having a narrow width while allowing a deviation from the lane having a narrow width.

When the temporary running road is set, it is determined whether a prohibited area, such as an obstacle, is present in the temporary running road on the basis of the information generated by the obstacle information processing unit 100. It is possible to determine whether a prohibited area is present in the temporary running road by comparing the coordinate information of the prohibited area with the coordinate information of the set temporary running road.

When it is determined that no prohibited area is present in the temporary running road, the temporary running road is directly set as a regular running road.

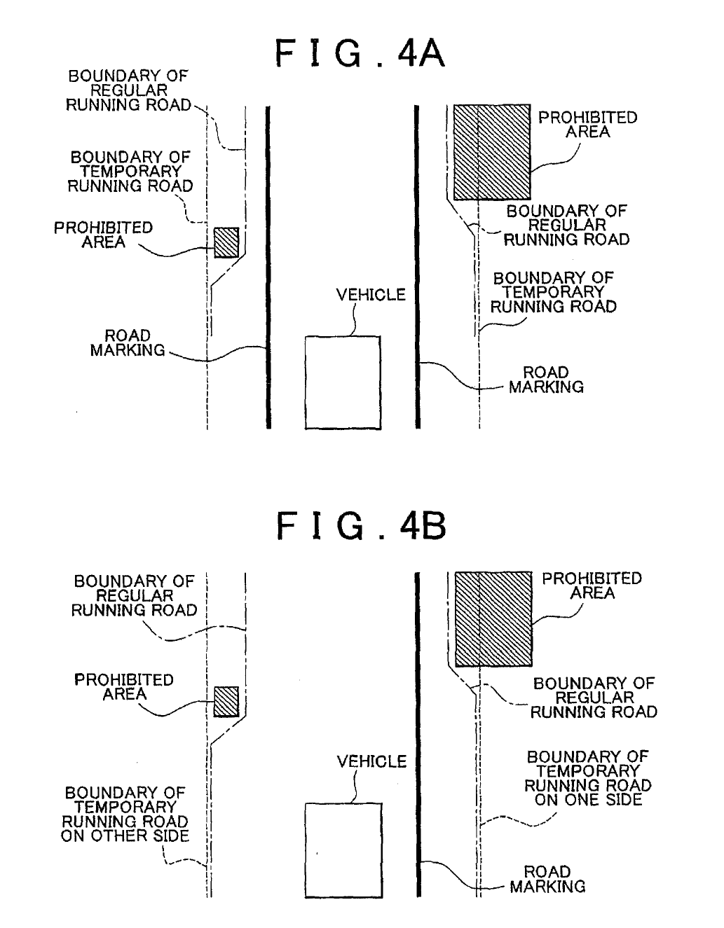

When it is determined that a, area is present in the temporary running road, the temporary running road is narrowed so as to avoid the prohibited area to set a regular running road. FIG. 4A and FIG. 4B are views that respectively show situations in which, when it is determined that there are prohibited areas in a temporary running road, the temporary running road is narrowed so as to avoid the prohibited areas to set a regular running road. FIG. 4A shows the case where road markings that indicate a lane boundary are respectively detected on both sides of a lane. FIG. 4B shows the case where a road marking that indicates a lane boundary is detected on one side of a lane. At this time, a temporary running road may be narrowed so as to avoid prohibited areas to set a regular running road with reference to the prohibited areas outside a lane having a narrow width. By so doing, it is possible to set a regular running road that avoids prohibited areas outside of a lane having a narrow width while allowing a, deviation from the lane having a narrow width. Note that, here, in the case where it is determined that prohibited areas are present in a temporary running road, when a regular running road becomes excessively narrow when the temporary running road is narrowed so as to avoid the prohibited areas, the running road may be curved so as to avoid the prohibited areas to set a regular running road.

With the above method, even when the width of a lane defined by a road marking that indicates a lane boundary is narrow, a running road is set by allowing a deviation from the lane having, a narrow width, and then the driving support apparatus may be operated. By so doing, it is possible to perform supporting so as to cause the vehicle to run within the running road without unnecessary support in the case where the vehicle deviates from a road marking that indicates a lane boundary that defines a lane having a narrow width. Thus, it is possible to effectively utilize the driving support apparatus by increasing a chance of using the driving support apparatus without unnecessary support.

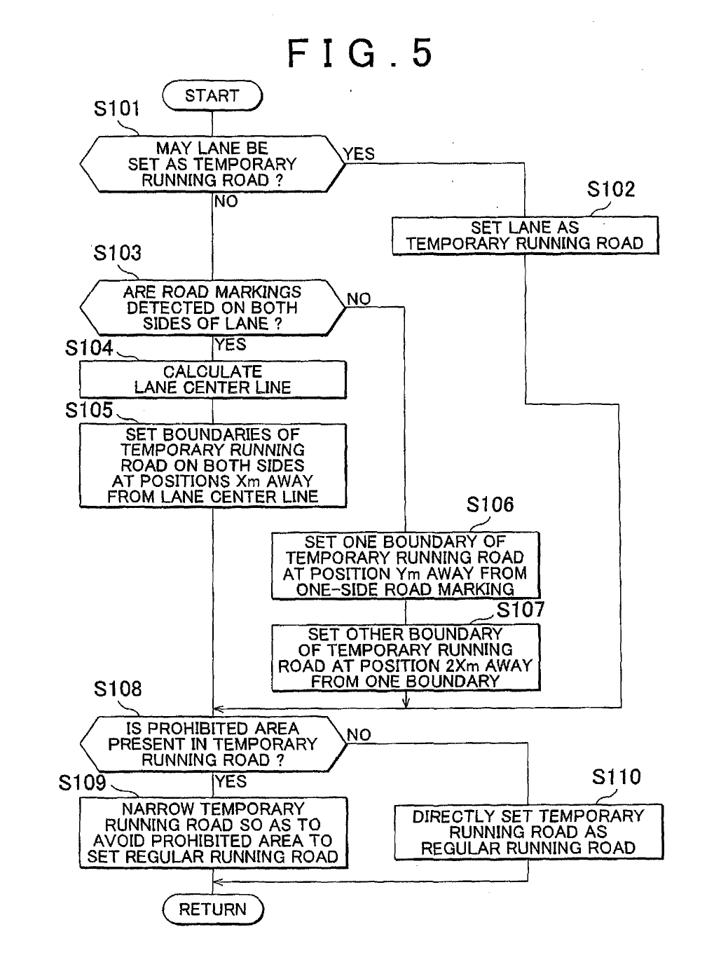

An integrated recognition processing control routine executed by the integrated recognition processing unit 104 will be described with reference to the flowchart shown in FIG. 5. FIG. 5 is a flowchart that shows the integrated recognition processing control routine. The routine is repeatedly executed by the integrated recognition processing unit 104 of the ECU 1 at predetermined intervals.

When the routine shown in FIG. 5 is started, it is determined in S101 whether a lane may be set as a temporary running road. When it is determined in S101 that a lane may be set as a temporary running road, the process proceeds to S102. When it is determined in S101 that a lane may not be set as a temporary running road, the process proceeds to S103.

In S102, the lane is set as a temporary running road. After the process of this step, the process proceeds to S108.

When it is determined that the width of the lane is narrow and the lane may not be set, as a temporary running road, in order to, set a temporary running road that deviates from the lane, it is determined in S103 whether road markings that indicate a lane boundary are detected on both sides of the lane. When it is determined in S103 that road markings that indicate a lane boundary are detected on both sides of the lane, the process proceeds to S104. When it is determined in S103 that road markings that indicate a lane boundary cannot be detected on both sides of the lane and a road marking that indicates a lane boundary is detected only on one side of the lane, the process proceeds to S106.

In S104, a lane center line between the road markings on both sides of the lane is calculated.

In S105, a temporary running road is set in such a manner that boundaries on both sides of the temporary running road are set at positions, which are located outside of the road markings, a predetermined distance (Xm) away from the lane center line calculated in S104 toward both sides. After the process of this step, the process proceeds to S108.

In S106, a boundary on one side of the temporary running road is set at a position a predetermined distance (Ym) away from a one-side road marking of the lane.

In S107, a boundary on the other side of the temporary running road is set at a position a predetermined distance (2Xm) away from the boundary on one side of the temporary running road set in S106 toward the opposite side of the lane. After the process of this step, the process proceeds to S108.

In S108, it is determined whether a prohibited area is present in the temporary running road. When it is determined in S108 that a prohibited area is present in the temporary running road, the process proceeds to S109. When it is determined in S108 that no prohibited area is present in the temporary running road, the process proceeds to S110.

In S109, the temporary running road is narrowed so as to avoid the prohibited area to thereby set a regular running road. After the process of this step, the routine once ends.

In S110, the temporary running road is directly set as a regular running road. After the process of this step, the routine once ends.

With the above described routine, even when the width of a lane defined by a road marking that indicates a lane boundary is narrow, a running road may be set by allowing a deviation from the lane having a narrow width.

The driving support apparatus according to the aspect of the invention is not limited to the above described embodiment; it may be modified in various forms without departing from the scope of the invention. In addition, the above embodiment is not only the embodiment of the driving support apparatus but also the embodiment of a driving support method.

1. A driving support apparatus that sets a running road, on which a vehicle is able to run, on the basis of a road marking that indicates a lane boundary or a prohibited area and that, when the vehicle deviates from the running road, issues a warning or performs assisting so as to cause the vehicle to run within the running road, characterized in that, when the width of a lane defined by the road marking that indicates the lane boundary is narrow, the running road is set by allowing a deviation from the lane having a narrow width.

2. The driving support apparatus according to claim 1, wherein the running road is set with reference to the prohibited area outside the lane having a narrow width.

3. The driving support apparatus according to claim 1 or 2, wherein the running road is set by changing a degree of influence of the road marking that indicates the lane boundary that defines the lane having a narrow width in response to the width of the lane having a narrow width.

4. The driving support apparatus according to any one of claims 1 to 3, wherein the running road is set by setting parallel lines that are parallel to the road marking that indicates the lane boundary that defines the lane having a narrow width and that deviate from the lane having a narrow width.

5. The driving support apparatus according to claim 1, wherein a temporary running road, at least one side of which is defined by a boundary located at a position outside of the road markings and a predetermined distance away from the road markings, is set, and
when no prohibited areas is present in the temporary running road, the temporary running road is set as the running road, on which the vehicle is able to run, and when the prohibited area is not present in the temporary running road, the temporary running road is narrowed so as to avoid the prohibited areas to set the running road, on which the vehicle is able to run.

6. The driving support apparatus according to claim 5, wherein the predetermined distance is changed in response to the width of the lane having the narrow width.

7. The driving support apparatus according to any one of claims 1 to 6, wherein the road marking that indicates the lane boundary is a line such as a white line, a yellow line and a dotted line, a median strip or a divider such as a raised marker and an illuminator, a boundary between a roadway and an area other than the roadway such as a boundary between asphalt and gravel, or the like, on a road surface.

8. The driving support apparatus according to any one of claims 1 to 7, wherein the prohibited area is an obstacle, such as a side wall, a curb, a pedestrian, a bicycle and another vehicle, or an area, such as a gutter and a step, that has a difference in height from a vehicle running plane.

9. A driving support method characterized by comprising:
setting a running road, on which a vehicle is able to run, on the basis of a road marking that indicates a lane boundary or a prohibited area, wherein, when the width of a lane defined by the road marking that indicates the lane boundary is narrow, the running road is set by allowing a deviation from the lane having a narrow width; and
when the vehicle deviates from the running road, issuing a warning or performing assisting so as to cause the vehicle to run within the running road.

10. A driving support apparatus comprising:
a controller that sets a running road, on which a vehicle is able to run, on the basis of a road marking that indicates a lane boundary or a prohibited area and that, when the vehicle deviates from the running road, issues a warning or performs assisting so as to cause the vehicle to run within the running road, wherein
when the width of a lane defined by the road marking that indicates the lane boundary is narrow, the controller sets the running road by allowing a deviation from the lane having a narrow width.
